(19) United States
(12) Patent Application Publication
(10) Pub. No.: US 2024/0401667 A1
(43) Pub. Date: Dec. 5, 2024

(54) Inerter-Based Elastic Metamaterials For Low-Frequency Vibration Mitigation

(71) Applicant: University of Utah Research Foundation, Salt Lake City, UT (US)

(72) Inventors: Pai Wang, Salt Lake City, UT (US); Fei Chen, Salt Lake City, UT (US)

(21) Appl. No.: 18/328,456

(22) Filed: Jun. 2, 2023

(51) Int. Cl. F16F 15/22; E02D 31/08

(52) U.S. Cl. CPC F16F 15/22; E02D 31/08; F16F 2222/08; F16F 2228/04

(57) ABSTRACT

An inerter-based metamaterial for low-frequency vibration attenuation includes a structural matrix material and an inerter array. The inerter array can be embedded within the structural matrix material. The inerter array can include a first inerter cell oriented along a first attenuation axis and a second inerter cell oriented along a second attenuation axis different from the first attenuation axis. The first inerter cell can include a first inerter. The second inerter cell can include a second inerter. The first inerter and the second inerter can be microinerters. The first inerter cell and the second inerter cell can be separated from each other by at least a portion of the matrix material. The first inerter cell and the second inerter cell can each include a first end and a second end and can each be connected to the matrix material at both the first end and the second end.

### CROSS REFERENCE TO RELATED APPLICATIONS

Not applicable

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION BY REFERENCE STATEMENT

An article including subject matter described herein was authored by the inventors and published in Extreme Mechanics Letters 56 (2022) 101847 under the title “Inerter-based elastic metamaterials for band gap at extremely low frequency” and dated 3 Jun. 2022. This article is incorporated by reference in its entirety herein.

### BACKGROUND

Vibration reduction, mitigation, and attenuation is important in various fields including construction, transportation, and machinery. For example, mitigating vibrations in buildings, whether commercial or residential, is an important consideration for safety as well as comfort of humans inhabiting or visiting such structures. For example, mitigating outside vibrations caused by nature (e.g., weather events or seismic activity) as well as human-caused vibrations (e.g., caused by construction, transportation, or simple human movement) can make buildings more stable, more structurally sound, and more resistant to damage. Additionally, vibration mitigation can reduce vibrations that can cause discomfort, injury, or irritation for humans. Similarly, it is desirable to mitigate vibrations in cars, airplanes, power tools, robots, and other types of transportation and machinery for similar purposes (i.e., structural safety and human comfort).

In the field of vibration mitigation, for the existing vibration-isolating materials that can operate ultralow-frequency vibrations (i.e., ultra-long wavelengths) in an ultra-compact way, either a decrease in the stiffness or increase in the mass of the resonators can be done as the resonance frequency is proportional to the square root of the ratio of stiffness over mass. This renders the material either too fragile (low stiffness) or too heavy (high mass) to be useful in practical applications.

For instance, many ground and air transport vehicles' typical vibration frequencies are in the range of 1 to 100 Hz. Existing materials, scatterers, and resonators would require units sized on the order of meters in order to effectively mitigate vibrations in the frequency range of 1 to 100 Hz. In another example, seismic activities typically have a wavelength in the kilometer (1000 m) range, which yields frequencies in the hundreds of kHz range. In accordance with previously-known wavelength-to-unit size ratios, conventional seismic vibration-mitigation materials would need to have a unit size in the range of several meters (e.g., 1 m-20 m) in order to sufficiently mitigate seismic vibrations. Such large materials and huge inertias (i.e., large masses) used to mitigate vibrations are often difficult to manufacture and are impractical in applications involving smaller buildings, transportation, and machinery since the size inerter used to mitigate low frequency vibration often exceeds the size of systems that exhibit such vibrations.

### SUMMARY

An initial summary of the disclosed technology is provided here. Specific technology examples are described in further detail below. This initial summary is intended to set forth examples and aid readers in understanding the technology more quickly but is not intended to identify key features or essential features of the technology nor is it intended to limit the scope of the claimed subject matter.

In one example of the present disclosure, an inerter-based metamaterial for low-frequency vibration attenuation is disclosed. The inerter-based metamaterial can include a structural matrix material and an inerter array embedded within the structural matrix material. The inerter array can include a first inerter cell oriented along a first attenuation axis and a second inerter cell oriented along a second attenuation axis different from the first attenuation axis. The first inerter cell can include a first inerter and the second inerter cell can include a second inerter. In at least one additional example, the first inerter and the second inerter can be microinerters.

In another example of the present disclosure, a building structure system is disclosed. The building structure system can include an inerter-based metamaterial for low-frequency vibration attenuation. The inerter-based metamaterial for low-frequency vibration attenuation can include a structural matrix material at least partially forming a structure of a building and an inerter array embedded within the structural matrix material. The inerter array can include a first inerter cell oriented along a first attenuation axis and a second inerter cell oriented along a second attenuation axis different from the first attenuation axis. The first inerter cell can include a first inerter and the second inerter cell can include a second inerter. In at least one additional example, the first inerter and the second inerter can be microinerters.

### BRIEF DESCRIPTION OF THE DRAWINGS

FIG. 1 is a schematic of an inerter in accordance with an example of the present disclosure.

FIG. 2A is a schematic of a ball-screw inerter in accordance with an example of the present disclosure.

FIG. 2B is a schematic of a rack-pinion inerter in accordance with an example of the present disclosure.

FIG. 2C is a schematic of a hydraulic inerter in accordance with an example of the present disclosure.

FIG. 3(a) is a schematic of an exemplary base structure or structural matrix material in accordance with an example of the present disclosure.

FIG. 3(b) is a schematic of an exemplary inerter-based metamaterial in accordance with an example of the present disclosure.

FIGS. 4A and 4B are dispersion relation plots of the performance of the inerter-based metamaterial of FIG. 3(b).

FIGS. 5A and 5B illustrate effects of change in the inertance ratio with a fixed stiffness ratio of the metamaterial of FIG. 3(b).

FIGS. 6A and 6B illustrate effects of change in the stiffness ratio with a fixed inertance ratio of the metamaterial of FIG. 3(b).

FIG. 7 is a schematic of a building system using the metamaterial of FIG. 3(b) in accordance with an example of the present disclosure.

FIG. 8 is a schematic of an exemplary inerter-based metamaterial in accordance with an example of the present disclosure.

FIGS. 9(a) and 9(b) are schematics of an exemplary inerter-based metamaterial in accordance with an example of the present disclosure.

FIG. 10A is a schematic of an inerter cell in an exemplary inerter-based metamaterial of FIG. 3(b).

FIG. 10B is a schematic square lattice structure of an exemplary inerter-based metamaterial of FIG. 3(b).

FIG. 10C is a schematic triangle lattice structure of an exemplary inerter-based metamaterial of FIG. 3(b).

FIG. 11A is a dispersion relation plot of the performance of the inerter-based metamaterial of FIG. 3(b) in the square lattice structure of FIG. 10B.

FIG. 11B is a dispersion relation plot of the performance of the inerter-based metamaterial of FIG. 3(b) in the square lattice structure of FIG. 10C.

These drawings are provided to illustrate various aspects of the invention and are not intended to be limiting of the scope in terms of dimensions, materials, configurations, arrangements or proportions unless otherwise limited by the claims.

### DETAILED DESCRIPTION

While these exemplary embodiments are described in sufficient detail to enable those skilled in the art to practice the invention, it should be understood that other embodiments may be realized and that various changes to the invention may be made without departing from the spirit and scope of the present invention. Thus, the following more detailed description of the embodiments of the present invention is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

### Definitions

In describing and claiming the present invention, the following terminology will be used.

The singular forms “a,” “an,” and “the” include plural referents unless the context clearly dictates otherwise. Thus, for example, reference to “a unit cell” includes reference to one or more of such cells and reference to “the spring” refers to one or more of such springs.

As used herein with respect to an identified property or circumstance, “substantially” refers to a degree of deviation that is sufficiently small so as to not measurably detract from the identified property or circumstance. The exact degree of deviation allowable may in some cases depend on the specific context.

As used herein, “adjacent” refers to the proximity of two structures or elements. Particularly, elements that are identified as being “adjacent” may be either abutting or connected. Such elements may also be near or close to each other without necessarily contacting each other. The exact degree of proximity may in some cases depend on the specific context.

As used herein, “operating wavelength” refers to a predominant wavelength of vibrations that the metamaterial structure is designed to mitigate or attenuate. Since the metamaterial is aimed at low frequency vibration reduction, its operating wavelength corresponds to wavelengths in the low frequency range of interest. This wavelength range in general is determined by the geometric dimensions, material selection (the b values, the main mass values and the stiffness), and overall design of the host, matrix, or substrate constituents in the metamaterials that surround the inerters.

As used herein, the term “about” is used to provide flexibility and imprecision associated with a given term, metric or value. The degree of flexibility for a particular variable can be readily determined by one skilled in the art. However, unless otherwise enunciated, the term “about” generally connotes flexibility of less than 2%, and most often less than 1%, and in some cases less than 0.01%.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

As used herein, the term “at least one of” is intended to be synonymous with “one or more of.” For example, “at least one of A, B and C” explicitly includes only A, only B, only C, or combinations of each.

Numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of about 1 to about 4.5 should be interpreted to include not only the explicitly recited limits of 1 to about 4.5, but also to include individual numerals such as 2, 3, 4, and sub-ranges such as 1 to 3, 2 to 4, etc. The same principle applies to ranges reciting only one numerical value, such as “less than about 4.5,” which should be interpreted to include all of the above-recited values and ranges. Further, such an interpretation should apply regardless of the breadth of the range or the characteristic being described.

Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given herein.

### Inerter-Based Elastic Metamaterials

Inerter-based elastic metamaterials are described and performance of various inerter-based elastic metamaterials can be quantified by a comparative study among different configurations of inerter-based elastic metamaterials. Additionally, the parametric studies in both one and two dimensions described herein outline principles for designing and manufacturing inerter-based elastic metamaterials for structural vibration mitigation that exhibit several advantages over previously known vibration mitigation materials, such as exhibiting improved band-gap formation in mitigating low and ultra-low frequency (i.e., long and ultra-long wavelength) vibrations. Furthermore, the inerter-based elastic metamaterials described herein achieve low and ultra-low frequency vibration mitigation while having a unit cell size that is multiple orders of magnitude smaller than the operating wavelength.

Mitigation of low-frequency vibrations has been a challenge in the field of vibration mitigation. This disclosure describes several architected materials, (e.g., referred to as acoustic or elastic metamaterials) and quantifies their performance in mitigating low-frequency vibrations. In vibration mitigation, there is currently no consensus on which frequency ranges should be called “low” or “ultra-low.” The exact meaning of low frequency varies from a fraction of one Hz to several Hz, and up to many kHz. The words “low” and “ultra-low” are used in the industry as relative concepts that depend on application-specific scenarios. For purposes of this disclosure, the vibrations will be referred to as “low-frequency” vibrations will be considered vibrations up to 20,000 Hz. However, in some cases the frequency can be from 20 to 100 Hz, in other cases 1 to 20 Hz, and in yet other cases 0.001 to 1 Hz. However, the design is scale-independent, and hence would work for any arbitrary frequency.

This disclosure illustrates and quantifies the capabilities of inerter-based metamaterials in forming band gaps at low and ultra-low frequencies. Prior to illustrating the abilities of inerter based metamaterials, several exemplary inerters used to mitigate vibrations are described with reference to the figures. The inerter-based metamaterials described herein can contain a plurality of inerters as a component of the metamaterial to form an inerter array. An inerter is a two-terminal mechanical device offering a frequency-independent inertial force much larger than its own physical mass. Similar to springs and dampers, inerters are passive devices without the need of any active control. Hence, this system fills a knowledge and capability gap in realizing inerter-based elastic metamaterials that can push the wavelength-to-unit ratio to more than 3 or 4 orders of magnitude and effectively control manipulate vibrations with ultra-deep sub-wavelength (i.e., ultra-compact) units.

A distributed array of inerters as metamaterials can be applied in very large structures to millimeter-scale structures. These inerter arrays have relatively small actual mass with a significantly large equivalent inertia, which greatly reduces the burden on the main structure. Further, by adjusting the values of inertance, stiffness, various range of frequencies can be matched to reduce vibrations. Distributed multiple subunits also collectively function together to exhibit excellent robustness against partial damage and partial malfunction. As such, these inerter metamaterials are capable of effectively reducing low-frequency vibrations through their small sizes and small actual masses. Sub-1 Hz frequencies are a particularly unique contribution to current options, since that is the most difficult range for existing vibration mitigation techniques.

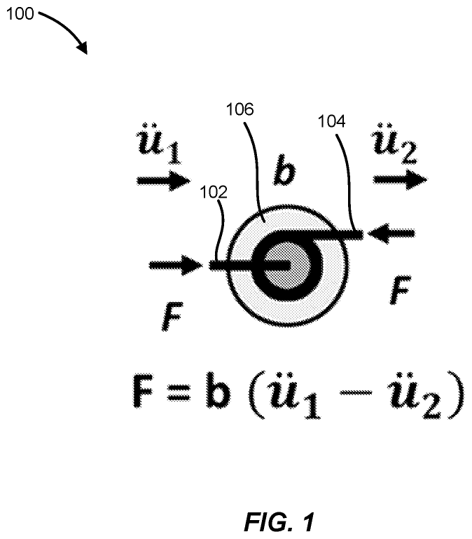

FIG. 1 illustrates a schematic illustration of the behavior of an inerter. As shown in FIG. 1, an inerter's behavior can be characterized by the response force F, which is defined by the expression: F=b(ü₁−ü₂), where ü₁ and ü₂ are the accelerations at the two terminals 102 and 104 of the inerter 100. The constant b is called the inertance of the inerter and has the same unit as mass. As shown in FIG. 1, the inerter 100 couples linear relative motions between its two ends (i.e., terminals 102 and 104) to the rotation of a flywheel 106. The flywheel moment of inertia can be amplified to produce a large inertial effect, thereby making it possible for the inerter to offer a frequency-independent inertial force much larger than its own physical mass. The use of rotational motion of the flywheel 106 also makes it possible for the device to be compact.

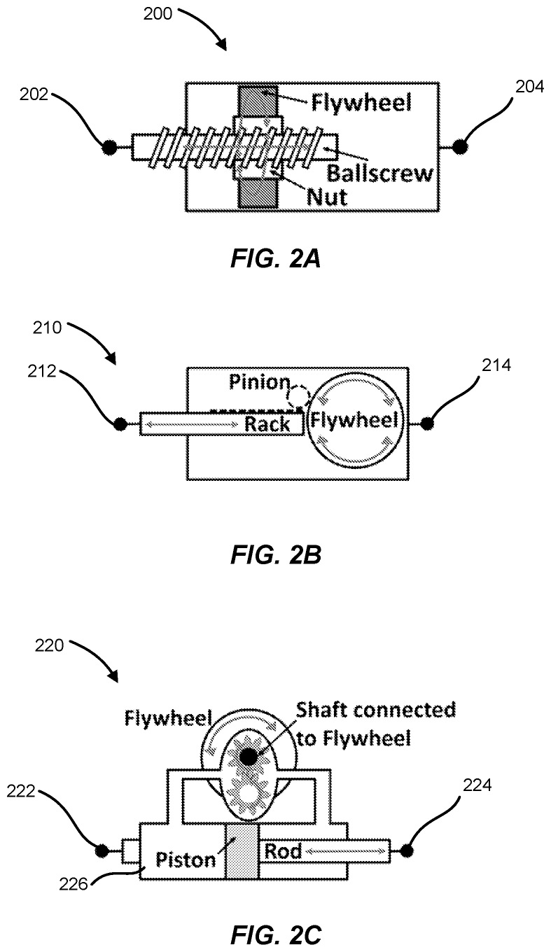

The performance attributes of different types of inerters have been experimentally verified. Various types of individual inerters have been experimentally characterized, including ball-screw inerters, rack-pinion inerters, and hydraulic inerters. FIG. 2A illustrates the basic design of a ball-screw inerter 200. As shown, the ball-screw inerter 200 can include first and second terminals 202 and 204 on opposite ends of the ball-screw inerter 200, a ballscrew threadably coupled to a nut that is coupled to a flywheel to provide inertance to the ball-screw inerter 200. FIG. 2B illustrates the basic design of a rack-pinion inerter 210. As shown, the rack-pinion inerter 210 can include first and second terminals 212 and 214 on opposite ends of the rack-pinion inerter 210, and a rack and pinion coupled to a flywheel to provide inertance to the rack-pinion inerter 210. The first terminal 212 can be at an end of the rack and the second terminal 214 can be at the flywheel. FIG. 2C illustrates the basic design of a hydraulic inerter 220. As shown, the hydraulic inerter 220 can include first and second terminals 222 and 224 on opposite ends of the hydraulic inerter 220. The hydraulic inerter 220 can further include a piston and rod configured to compress fluid in a reservoir 226 to drive a flywheel via turning gears connected to a shaft that is coupled to the flywheel in order to provide inertance to the hydraulic inerter 220. The hydraulic inerter design benefits from the small physical mass of nearly incompressible fluid that fills the inerter 220, so that it can produce an inertance that can be 1.5×10⁶ times larger than its own the physical mass.

While a few exemplary inerters are illustrated in the figures, it is to be understood that the type of inerters used in a metamaterial described herein are not intended to be limited in any way. Additional inerter designs and structures are contemplated within the scope of this disclosure, including fluid inerters, hydraulic inerters, living-hinge inerters, planetary-gear inerters, rack-and-pinion inerters, ball-screw inerters, and any other inerter structures.

The discussion below outlines a study to identify and overcome hurdles in incorporating inerters into metamaterial designs. Theoretical and numerical analyses of different designs and models of inerters in metamaterials are described below to identify challenges and to realize vibration-band gap metamaterials.

To facilitate meaningful discussion and a fair comparison among different systems and configurations, each design will be evaluated by focusing on a universal and dimensionless frequency for vibro-elastic metamaterials. The dimensionless frequency is represented by the expression f=a/λ where a denotes the size of a metamaterial unit, and λ is the operating wavelength. For example, scattering-based band gaps in phononic crystals are at the order of f=a/λ˜1. In contrast, locally resonant metamaterials embedded with mass-resonators usually exhibit band gaps at a much lower frequency range of f=a/λ˜10⁻² to 10⁻³. However, the numerical analysis described below demonstrate the unique capability and advantage exhibited by inerter-based metamaterials in forming band gaps at ultra-low dimensionless frequencies, where f=a/λ˜10⁻⁴. Additionally, the numerical analysis described below allow for the achievement and realization of vibration-band gap metamaterials with small unit cells in the ultra-deep sub-wavelength scale of f=a/λ˜10⁻⁴.

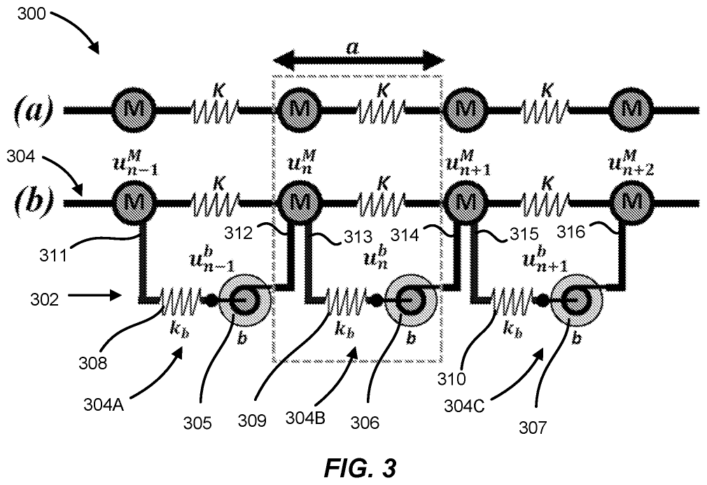

The numerical analysis models any structural matrix material, or the base structure of metamaterials, as a spring-mass chain with a stiffness K (or in other words, a spring) and a point mass M. In FIG. 3(a), an abstraction/model of any structural matrix material 300 as a spring-mass chain is illustrated. The structural matrix material 300 includes a chain of stiffnesses K and point masses M, where a denotes the size of a metamaterial unit, which is shown in FIG. 3(a) as a dashed box surrounding the metamaterial unit a of the structural matrix material 300. This model was chosen as valid model aiming to have a long-wavelength limit of λ>>a, where the discrete nature of the structural matrix material 300 has negligible impact on the results. Having a goal where λ>>a, allows for a small unit size a to be much smaller than the wavelength A of the vibrations being mitigated. With the structural matrix material 300, metamaterial dispersion relations according to the main-chain wave speed in the long-wavelength limit can be normalized so that band gap frequencies are non-dimensionalized as

$$f = \frac{ω a}{2 π c} = \frac{a}{λ} ,$$

where ω is the dimensional angular frequency in metamaterial dispersion relations. The long wavelength limit is defined as c=a\sqrt{K/M}.

With the model of the matrix material or base structure (e.g., the structural matrix material 300) in place, three different types of metamaterial designs were analyzed, including: (1) a metamaterial design with embedded inerters; (2) a metamaterial design with inerter-mass-resonators; and (3) a metamaterial design with traditional mass-resonators.

As shown in FIG. 3(b), the first inerter-based metamaterial 302 can be for low-frequency vibration attenuation and can include a structural matrix material 300, which is shown alone in FIG. 3(a) and is shown as part of a metamaterial in FIG. 3(b). The structural matrix material 300 can include a chain of masses M and stiffnesses K. The inerter-based metamaterial 302 can further include an inerter array embedded within the structural matrix material 300. The inerter array 304 can include a first inerter cell 304A, a second inerter cell 304B, a third inerter cell 304C, and so on. The number of inerter cells in an inerter-based metamaterial is not intended to be limited in any way by this disclosure. The number of inerter cells in the metamaterial 302 can number one, two, three, four, or more without any intended limitation. As a non-limiting example, the number of inerter cells can number from 5 to 10,000 inerter cells in a metamaterial. The cells can be fully embedded (i.e. entirely surrounded) by the corresponding matrix material such that they are non-accessible once the metamaterial is formed. However, in some cases all or a portion, of the inerters can be fully or partially exposed.

As an example, within a building structure, each floor or each load-bearing column can be regarded as a structural matrix material 300. To enhance seismic resistance, a customized configuration of inerter arrays 304 can be embedded in the normal (e.g. steel/concrete) structural components. By incorporating this targeted design, the desired metamaterial 302 can be effectively achieved. In general, the “matrix” actually can be any material or structure, natural or man-made. Non-limiting examples of matrix material can include metal, concrete, reinforced concrete, rubber, ceramic, soil, rock, wood, truss lattice, building foundation, bridge foundation, airfoil, automotive suspension, and the like. The arrangement direction of inerter arrays 304 can be determined based on the specific circumstances and requirements of the building. For example, for buildings and bridges, inerter arrays 304 can be more than 90% of inerters aligned in the horizontal direction to reduce the lateral vibrations, which are the most detrimental vibration mode during a typical earthquake. For bomb shelters, inerter arrays 304 can be randomly distributed or arranged in a dispersed manner to reduce unpredictable external excitations associated with varying circumstances from unknown directions. The setting of parameters such as inertance, mass, stiffness, and others can utilize data derived from the environment and local historical records of the building's location.

In this example, each inerter cell (e.g., 304A, 304B, 304C) can be oriented along an attenuation axis. For example, as shown in FIG. 3(b), the inerter cells 304A, 304B, and 304C are schematically shown to be oriented in the same direction (e.g., from left to right on the drawing page). However, the disclosure is not intended to be so limited and the inerter cells can, in practice, all be oriented in a same direction (e.g., along a first attenuation axis). Alternatively, at least two of the inerter cells can be oriented along a same attenuation axis (e.g., first attenuation axis) while other inerter cells are oriented along a different attenuation axis (e.g., second attenuation axis) oriented in a different direction. Alternatively, all inerter cells can be oriented along different attenuation axes (e.g., first, second, third, fourth attenuation axes, etc.). Accordingly, the inerter based metamaterial 302 can be a one-dimensional, two-dimensional, or three-dimensional metamaterial including a one-dimensional, two-dimensional, or three-dimensional inerter array.

As a general guideline, for seismic applications, the lateral vibration (i.e. surface shear “Love wave” of the ground) is almost always the dominant mode of damage to buildings and bridges. Accordingly, it can be useful to orient at least 90% of the inerters in the horizontal direction along the surface shear direction, and in some cases at least 90% of the inerters can be oriented within 5% of the surface shear direction. For other scenarios, desirable inerter orientation can be case-dependent and the inerter-based metamaterial can be customized to applications according to practical considerations in general. For example, bomb shelters may include varied inerter orientations distributed throughout the matrix in order that some predefined percentage of inerters fall along each of several axis directions (e.g. among 3-10 directional axis). The percentage of inerters falling in each direction can be determined based on design criteria and assessments of likely shear wave propagation directions. Similarly, for civil infrastructure, such as buildings and bridges may incorporate varied inerter metamaterials to mitigate wind/seismic-induced vibrations. In these examples, more than 90% of the inerters can be aligned in the horizontal direction since shearing vibrations are the most detrimental shaking during a typical earthquake. This strategic alignment allows for enhanced control and stabilization, effectively reducing the impact of lateral forces on structural integrity of the corresponding structure.

In the inerter-based metamaterial 302, the first inerter cell 304A can include a first inerter 305, the second inerter cell 304B can include a second inerter 306, and the third inerter cell 304C can include a third inerter 307. Additional inerter cells can be added and can each include their own respective inerters. The number of inerter cells in the metamaterial is not intended to be limited. Additionally, each of the first, second and third inerter cells 304A, 304B, and 304C, (and any number of additional inerter cells) can include a stiffness k_{b} (e.g., stiffnesses 308, 309, and 310) connected to their respective inerters (e.g., 305, 306, and 307). The stiffnesses k_{b} can each be connected in series to their respective inerters (e.g., 305, 306, and 307), as shown in FIG. 3.

The inerters 305, 306, and 307 in each of inerter cells 304A, 304B, and 304C are mass-inerters. Without any intended limitation, the inerters 305, 306, and 307 can be at least one of a ball-screw inerter, a rack-and-pinion inerter, a hydraulic inerter, a fluid inerter, a living-hinge inerter, and a planetary-gear inerter.

As further shown in FIG. 3(b), each inerter cell can include a first end and a second end and each inerter cell can be connected to the structural matrix material at both the first end and the second end. For example, the first inerter cell 304A can include a first end 311 connected to the structural matrix material 300 at a first point (e.g., at one of the point masses M), and can include a second end 312 connected to the structural matrix material 300 at a second point (e.g., at another one of the point masses M different from the point mass M where the first end 311 is connected). The second inerter cell 304B can include a first end 313 connected to the structural matrix material 300 at a first point (e.g., at one of the point masses M), and can include a second end 314 connected to the structural matrix material 300 at a second point (e.g., at another one of the point masses M different from the point mass M where the first end 313 is connected). The third inerter cell 304C can include a first end 315 connected to the structural matrix material 300 at a first point (e.g., at one of the point masses M), and can include a second end 316 connected to the structural matrix material 300 at a second point (e.g., at another one of the point masses M different from the point mass M where the first end 313 is connected). If any additional inerter cells are included in the metamaterial (e.g., metamaterial 302), in one example, each of the additional inerter cells can also comprise a first end and a second end connected to the structural matrix material at different respective points.

As described above, each of a plurality of inerter cells in an inerter-based metamaterial can include a first end and a second end, and each of the plurality of inerter cells can be connected to the structural matrix material at both the first end and the second end, as shown in FIG. 3(b). Alternatively, not all of the plurality of inerter cells necessarily need to have a first end and a second end. At least some, but not all, of the inerter cells of the plurality of inerter cells can include a first end and a second end. Furthermore, at least some, but not all, of the inerter cells of the plurality of inerter cells can be connected to the structural matrix material at both the first end and the second end. In some cases, at least 5% of the inerters are connected to the matrix material at both the first and second ends, in other cases at least 20%, in still other cases at least 50%, in some cases at least 90%, and in other cases substantially 100%. As further shown in FIG. 3(b), at least some of the inerter cells 304A, 304B, and 304C can be separated from each other by at least a portion of the structural matrix material 300. For example, the second end 312 of the first inerter cell 304A is connected to the structural matrix material 300 and the first end 313 of the second inerter cell 304B is also connected to the structural matrix material 300. However, as shown in FIG. 3(b), the first end 313 and the second end 312 are not connected to each other. Accordingly, the first inerter cell 304A and the second inerter cell 304B are separated from each other by at least a portion of the structural matrix material (e.g., the mass point M where both the first end 313 and the second end 312 of the respective inerter cells 304A and 304B are connected to the structural matrix material 300). A similar connection relationship is shown between the second inerter cell 304B and the third inerter cell 304C. Additional inerter cells can have a similar connection relationship with adjacent inerter cells in which pairs of adjacent inerter cells in an inerter array are separated from each other by at least a portion of the structural matrix material.

With the connection relationships described above between inerter cells and the structural matrix material, most of the plurality of inerter cells of the inerter array can be separated from other adjacent inerter cells of the inerter array by at least a portion of the matrix material such that the plurality of inerter cells are connected to each other via the matrix material. Alternatively, all, or in other words, each of the plurality of inerter cells of the inerter array can be separated from other inerter cells of the inerter array by at least a portion of the structural matrix material such that the plurality of inerter cells are connected to each other via the structural matrix material.

As examples, the three analyzed metamaterial designs are respectively shown in FIGS. 3(b), 8, and 9. To analyze each of the metamaterial designs, the Bloch theorem was applied to calculate the dispersion relations of each system and investigate each systems' behaviors at the low-frequency/long-wavelength limit of λ>>a. As a first numerical analysis, the inerter-based metamaterial of FIG. 3(b) (e.g., metamaterials with embedded inerters and no other additional mass) was considered.

As shown in FIG. 3(b), the modeled metamaterial 302 has two degrees of freedom in the unit cell: u^{M}, which is a displacement of each mass M on the main chain of the structural matrix material 300, and u^{b}, which is a displacement of the point between stiffness k_{b} and inerter b on the side chain. Each mass M has a displacement u^{M} with each discrete displacement u^{M} for the separate masses M being identified in FIG. 3(b) with a subscript of n−1, n, n+1, and n+2. Similarly, each separate displacement u^{b} of each inerter cell 304A, 304B, and 304C, is identified in FIG. 3(b) with a subscript of n−1, n, n+1, and n+2.

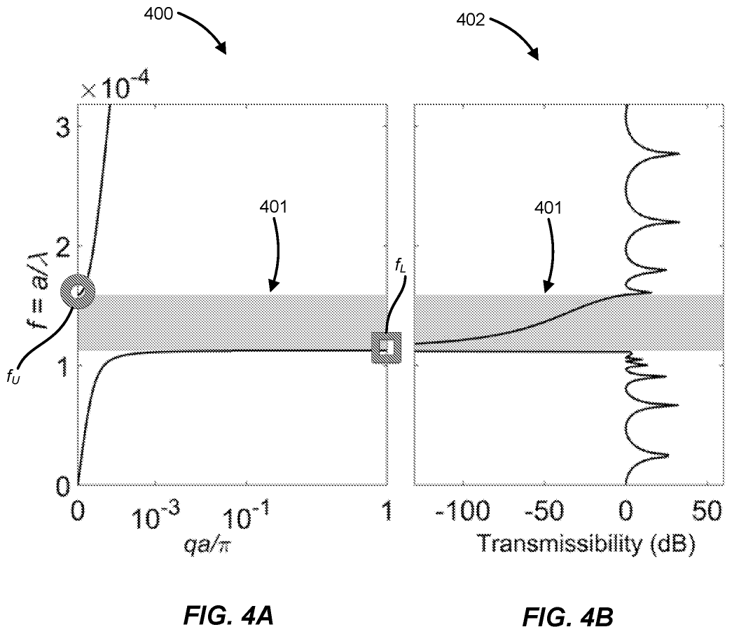

Using the following parameters k_{b} K=1 and b/M=10⁶, a dispersion relation was plotted for the metamaterial 302 of FIG. 3(b). The dispersion relation plot 400 is shown in FIG. 4A. In FIG. 4A, a band gap 401 is shown as the grey-shaded range near f=a/λ˜10⁻⁴. The horizontal axis of a normalized wave number qa/π is shown in a logarithmic scale because the band-gap effects happen at very long wavelengths, which makes the logarithmic scale better for illustrating the band-gap effects. The ultra-low frequency band gap 401 is further demonstrated by the illustrated transmission attenuation in a steady-state dynamics simulation of a finite chain response of an inerter-based metamaterial 302 having 1000 unit cells, which results are plotted 402 and displayed in FIG. 4B. For the results shown in FIG. 4B, the transmissibility is calculated as the ratio between output and input amplitudes.

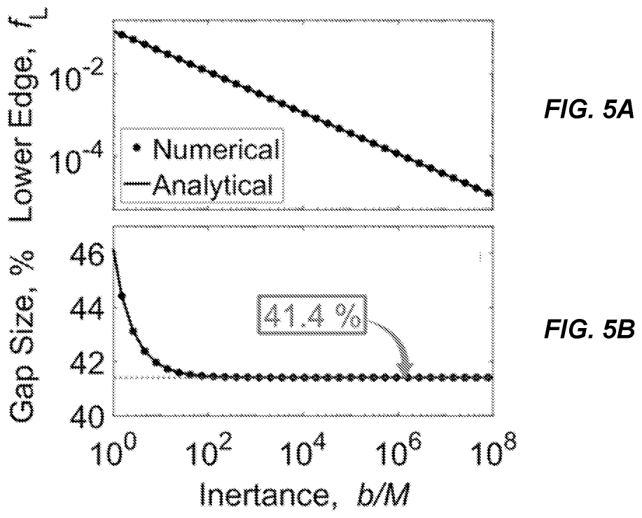

The band gap's 401 lower edge frequency, f_{L}, is the eigen-frequency of the first band at q=π/a, as labelled by a grey square in FIG. 4A. Similarly, the band gap's upper edge frequency, f_{U}, is the eigen-frequency of the second band at q=0, as labelled by a grey circle in FIG. 4A. As acceptable non-dimensionalized measures for comparison purposes, we characterize the band gap by two quantities: (1) The starting dimensionless frequency, f_{L}; and (2) The relative gap size Δf=(f_{U}−f_{L})/f_{L}. Parametric studies on the band gap lower edge frequency f_{L} and relative gap size Δf were carried out and plotted in FIGS. 5A and 5B. The results of the parametric studies for the dimensionless frequency f_{L} and the relative gap size Δf for a range of inertance ratios μ_{b} (defined as μ_{b}=b/M) of the metamaterial 302 are plotted and shown in FIGS. 5A and 5B, respectively. The plots in FIGS. 5A and 5B illustrate the effects of change in the inertance ratio uh, with a fixed stiffness ratio κ_{b} in which κ_{b}=kₙ/K=1. As shown, the numerical results of the analysis metamaterial 302 are f_{L}=1.125×10⁻⁴ with a relative gap size of Δf≈41.4%.

From the results shown in FIGS. 5A and 5B, analytical equations for the band gap lower edge frequency f_{L} and the band gap upper edge frequency f_{U} can be obtained, as shown below:

$${f}_{L} = \frac{1}{2 π} \sqrt{{χ}_{b} - \sqrt{{χ}_{b}^{2} - 4 \frac{{κ}_{b}}{{μ}_{b}}}} and {f}_{U} = \frac{1}{2 π} \sqrt{\frac{{κ}_{b}}{{μ}_{b}}} ,$$

where χ_{b}=2κ_{b}+κ_{b} (2μ_{b})+2, κ_{b}=k_{b} K, and μ_{b}=b/M. The closed form results provided by the equations above enable the performance of asymptotic convergence analyses. For example, at the limit of a very large inertance μ_{b} compared to the stiffness κ_{b}, (e.g., μ_{b}>>κ_{b}), equations for the band gap lower edge frequency f_{L} and the relative gap size Δf are as follows:

$${f}_{L} \to \frac{1}{2 π} \sqrt{\frac{{κ}_{b}}{{μ}_{b} ( {κ}_{b} + 1 )}} and Δ f \to \sqrt{{κ}_{b} + 1} - 1.$$

The equations derived and shown above reveal a unique advantage of the metamaterial design 302 having embedded inerters. The advantage of the embedded inerter metamaterial design 302 is that as the inertance b=μ_{b}M increases, the band gap shifts to a lower frequency. At the same time, the relative gap size, Δf, approaches a finite and low limit, keeping the band gap open at very low frequencies. This convergence is shown and observed with numerical results in FIGS. 5A and 5B with κ_{b}=k_{b}/K=1, where the gap size converges to Δf=\sqrt{2}−1≈41.4% for large values of μ_{b}. Additionally, using the same limit (e.g., μ_{b}>>κ_{b}), the modal displacement ratios at the band gap edges can be established with the following equations:

$${U}^{b} / {U}^{M} \to 1 + 2 / {κ}_{b} at f = {f}_{L} ,$$

$${U}^{b} / {U}^{M} \to 1 at f = {f}_{U} ,$$

where U^{b} and U^{M} are modal amplitudes of u^{b} and u^{M}, respectively. Taking an additional limit modeling very high stiffnesses in the inerter, (e.g., κ_{b}>>1), gives the following equations:

$${f}_{L} \to \frac{1}{2 π} \sqrt{\frac{1}{{μ}_{b}}} , Δ f \to \sqrt{{κ}_{b}} ,$$

$${U}^{b} / {U}^{M} \to 1 at both {f}_{L} and {f}_{U} .$$

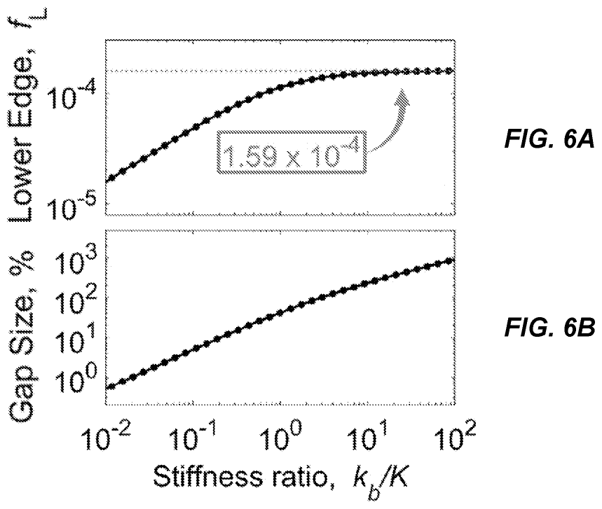

The above equations show that it is beneficial to have stiff connections between the inerter and the main chain in the metamaterial 302, because a larger band gap size can be achieved as k_{b}=κ_{b}K increases and the band gap's starting frequency will saturate and converge to a finite limit, thus retaining the ultra-low frequency feature with large inertance. To show this, additional parametric studies on the band gap lower edge frequency f_{L} and relative gap size Δf were carried out. These results of the parametric studies for the dimensionless frequency f_{L} and the relative gap size Δf were carried out for a range of stiffness ratios κ_{b} in which κ_{b}=k_{b}/K with a fixed inertance ratio μ_{b} (defined as μ_{b}=b/M=10⁶) of the metamaterial 302. The results are plotted and shown in FIGS. 6A and 6B, respectively. As shown, the numerical results of the analysis of metamaterial 302 are that the band gap lower edge frequency f_{L} converges to f_{L}=10⁻³/(2π)≈1.59×10⁴.

According to the analysis above, the inerter-based metamaterial 302 designed and described above can offer unprecedented advantages with highly distributed applications and robustly damage-tolerant vibration control functionalities. The metamaterial 302 can be installed on different parts of the building/vehicle/structure and can be applied to multiple fields and structures where vibration mitigation in low frequencies is desired. Furthermore, with the high number of inerter cells (e.g., 10,000) being installed in the structural matrix material, redundancy allows the metamaterial 302 to still work well, even in situations where a large percentage of the unit cells are broken, damaged, or disconnected from the matrix material.

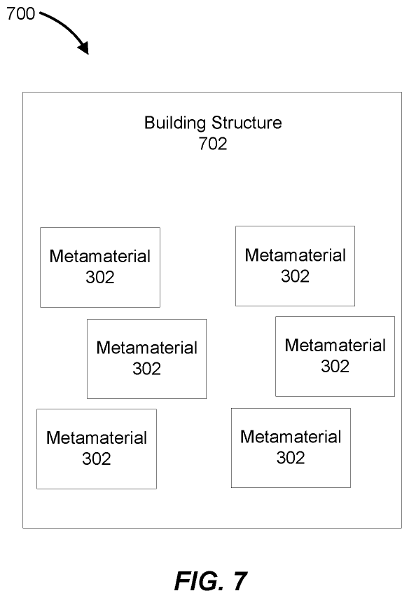

As one example, the metamaterial 302 can be used in a building structure system 700, as illustrated in FIG. 7. The building structure system can include framings, trusses, foundations, columns, beams, load-bearing walls and other main structures and load-bearing structures. The building structure system can include an inerter-based metamaterial 302 for low-frequency vibration attenuation. As described above, the metamaterial can include a structural matrix material 300 at least partially forming a structure 702 of a building. The metamaterial can further include an inerter array 304 embedded within the structural matrix material. The inerter array can include a first inerter cell 304A oriented along a first attenuation axis and a second inerter cell 304B oriented along the first attenuation axis, or alternatively, a second attenuation axis different from the first attenuation axis. The first inerter cell can include a first inerter 305 and the second inerter cell can comprises a second inerter 306. The system can then be operable to mitigate low frequency vibrations in the building structure 702. Generally, the inerter array can include inerters in a regular array (i.e. evenly and regularly spaced) or may include all or some portion of the inerters oriented in a non-regular pattern. The non-regular pattern can include variations in distances between inerters, as well as variations in attenuation axis orientation. As a general guideline, alignment criteria for inerters can be heavily application dependent and expected directions of vibration and seismic waves. For example, if no dominant propagation direction is known a priori, then a random alignment of inerter axes can be used. Similarly, concentration of inerters can be varied across a matrix by increasing concentration of inerters in critical parts of a structure, or areas expected to receive higher amplitude waves.

As illustrated in the numerical analysis above, metamaterial 302 will be able to effectively reduce vibrations in ultra-low-frequency ranges. The metamaterial can further be made of many small inerter cells that are microinerter cells having microinerters therein. For example, as discussed above and shown in the numerical analysis of metamaterial 300, it is possible to fabricate inerters with inertance more than a million times of its actual mass (μ_{b}˜10⁶) such that the inerters in the embedded inerter metamaterial 302 shown in FIG. 3 can be sized very small (e.g., millimeters to centimeters). Using many microinerters sized in the millimeter to centimeter range can effectively mitigate vibrations in the low and ultra-low frequency ranges, making the metamaterial 302 practical, sizable, and able to be miniaturized for use in a wider variety of engineering applications than has been known previously. Therefore, the unit cell size of the inerter cells and inerters can be on the order of millimeters to centimeters. Although sizes can vary based on application and design criteria, as a general guideline the inerter cells can be 1 mm to 10 meters and in some cases up to 1000 cm, and in some cases 1 cm to 20 cm. However, the size of inerter cells can depend on specific requirements of the application environment. For instance, in the case of automotive and aerospace applications that prioritize maneuverability, inerter cell components of approximately 10 cm may be considered most suitable. On the other hand, for commercial office buildings and similar structures, inerter cells components ranging from 20 cm to 50 cm may be most advantageous. Furthermore, the size of inerter cells is a function of the desired materials, manufacturing processes, and budget constraints.

This is much smaller than the size of typical structural components in civil engineering or the size of any vehicle suspension system and illustrates that very low frequency vibrations can be mitigated with many very small size inerters and inerter cells coupled to a structural matrix material to form an inerter-based metamaterial. For instance, many ground and air transport vehicles' typical vibration frequencies are in the range of 1 to 100 Hz. Existing materials, scatterers, and resonators would require units sized on the order of meters in order to effectively mitigate vibrations in the frequency range of 1 to 100 Hz. Seismic activities typically have a wavelength in the kilometer (1000 m) range, which yields frequencies in the hundreds of kHz range. In accordance with previously-known wavelength-to-unit size ratios, conventional seismic vibration-mitigation materials would have a unit size in the range of several meters (1 m-10 m) in order to sufficiently mitigate seismic vibrations. However, the metamaterial 302 described herein can mitigate such frequencies with inerters that are sized in millimeter to centimeter sizes, thereby showing much easier manufacturability and usability over currently known low-frequency vibration mitigation devices.

The miniaturization of the inerter cells achieves a new class of metamaterials described herein for a highly distributive, purely passive, low-maintenance, and fault-tolerant solution to low frequency vibration mitigation. By breaking the fundamental limit in wavelength-to-unit ratio, the new class of metamaterials can mitigate ultralow-frequency vibrations in a much wider range of mechanical systems than was previously possible. Although a varieties of manufacturing techniques can be used, micro-inerters can typically be produced via additive printing and/or high-precision direct numerical control (DNC) machining that are popular in many engineering processes.

The numerical analysis of metamaterial 302 above reveals unique and fundamental advantages of inerter-based elastic metamaterials by a comparative study among different configurations (which are described below). With the embedded inerter connected to the matrix material on both ends as described above, the metamaterial 302 shows definite superiority in forming a band gap in the ultra-low frequency and ultra-long wavelength ranges, where the unit cell size can be four or more orders of magnitude smaller than the operating wavelength. The analysis described above and the principles described therein further paves the way towards designing next-generation metamaterials for structural vibration mitigation in the low and ultra-low frequency ranges.

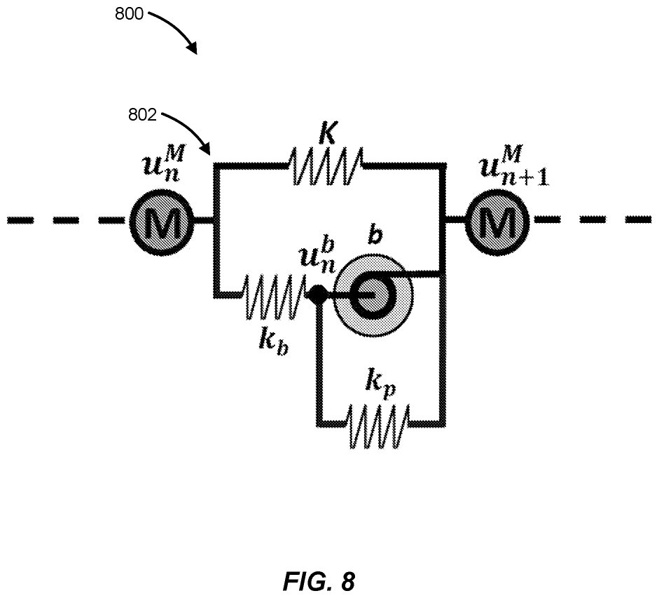

To further illustrate the advantages of metamaterial 302 described above, additional analyses were carried out on additional structures of metamaterials. For example, a variant design of metamaterial involves adding an additional stiffness, kₚ, parallel to the embedded inerter b. An exemplary configuration of a metamaterial 800 having a metamaterial inerter unit cell 802 including an additional stiffness kₚ connected in parallel with the inerter b is shown in FIG. 8. As shown in FIG. 8, each unit cell 802 still has two degrees of freedom. A similar numerical analysis to that performed on metamaterial 302 is described now with respect to metamaterial 800 and unit cell 802. Using the same analyses as before, equations for both upper and lower edge frequencies f_{U} and f_{L} of the band gap can be obtained. The equations are as follows:

$${f}_{L} = \frac{1}{2 π} \sqrt{{χ}_{p} - \sqrt{{χ}_{p}^{2} - \frac{4 ( {κ}_{b} + {κ}_{b} {κ}_{p} + {κ}_{p} )}{{μ}_{b}}}} ,$$

$${f}_{U} = \frac{1}{2 π} \sqrt{\frac{( {κ}_{b} + {κ}_{p} )}{{μ}_{b}}} ,$$

where χₚ=2κ_{b}+(κ_{b}+κₚ)/(2μ_{b})+2, κ_{b}=k_{b}/K, κₚ=kₚ/K, and μ_{b}=b/M. The closed form results provided by the equations above enable the performance of asymptotic convergence analyses. For example, at the limit of a very large inertance μ_{b} compared to the stiffness κ_{b}, κₚ (e.g., μ_{b}>>κ_{b}, κₚ) and setting κ_{b}=1, the asymptotic convergence equations for the band gap lower edge frequency f_{L} and the relative gap size Δf are as follows:

$${f}_{L} \to \frac{1}{2 π} \sqrt{\frac{2 {κ}_{p} + 1}{2 {μ}_{b}}} and Δ f \to \sqrt{1 + \frac{1}{2 {κ}_{p} + 1}} - 1 ,$$

which indicate that, as the parallel stiffness κₚ increases, f_{L} gets higher and Δf gets smaller. Accordingly, the parallel stiffness κₚ has only detrimental effects to band gap formation for mitigating low and ultra-low frequency vibrations. In other words, parallel stiffness κₚ can be set to zero to achieve both design objectives described herein of a lower band gap lower frequency f_{L} and a larger band gap size/range.

Therefore, the metamaterial design 302 shown in FIG. 3 is advantageous over the metamaterial 800 of FIG. 8. In other words, the metamaterial 302 having large inertance and stiff connections with the structural matrix material 300 performed better at achieving a low band gap lower frequency f_{L} and a larger band gap size/range than the metamaterial 800 that incorporated a parallel stiffness κₚ with the inerter b.

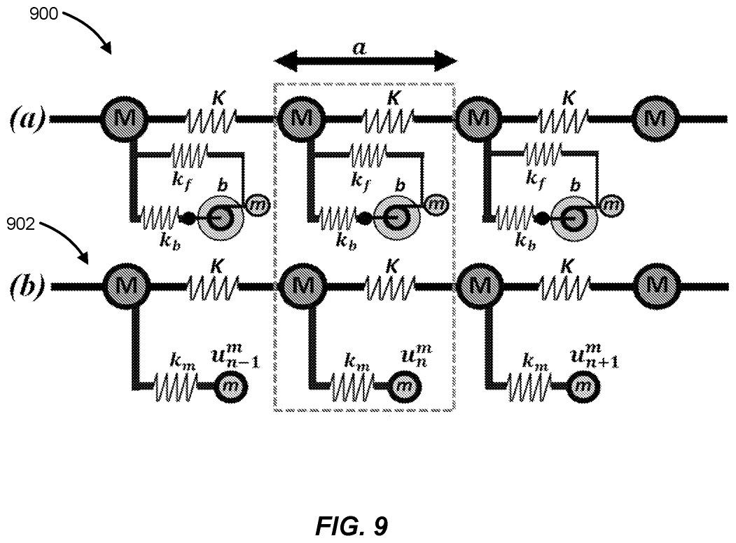

To further illustrate the advantages of metamaterial 302 described above, additional analyses were carried out on additional structures of metamaterials. For example, an alternative design of metamaterial involves using embedded mass-inerter resonators in a structural matrix material. Such a configuration is shown in FIG. 9(a) as metamaterial 900. As shown, metamaterial 900 includes inerter cells where one end of the inerter is connected to the main chain, while the other end is connected to a resonator mass m. Such a configuration results in a model metamaterial 900 with three degrees of freedom in each unit cell: u^{M} which is displacement of mass M on the main chain, u^{b} which is displacement of the point between stiffness k_{b} and inerter b, and u^{m} which is displacement of the resonator mass m. Applying the same Bloch-wave procedures used for previous numerical analysis yields dispersion band equations for metamaterial 900. At the limit of large inertance (e.g., μ_{b}>>μₘ, κ_{b}, κ_{f}) and low frequency (e.g., 1>>f), the equations yielded are as follows:

$${f}_{L} \to \frac{1}{2 π} \sqrt{\frac{{κ}_{b} {κ}_{m}}{{μ}_{b} ( {κ}_{b} + {κ}_{m} )}} and Δ f \to 0 ,$$

where μ_{b}=b/M, μm=m/M, κ_{b}=k_{b}/K, and κ_{f}=k_{f}/K. As shown in the equation, increasing the inertance μ_{b} closes the band gap (Δf→0). Therefore, the metamaterial design 302 shown in FIG. 3 is advantageous over the metamaterial 900 of FIG. 9. In other words, the metamaterial 302 having large inertance and stiff connections with the structural matrix material 300 performed better at achieving a low band gap lower frequency f_{L} and a larger band gap size/range than the metamaterial 900 including the embedded mass-inerter resonators.

To further illustrate the advantages of metamaterial 302 described above, additional analyses were carried out on additional structures of metamaterials. For example, an alternative design of metamaterial traditional locally resonant metamaterials with embedded mass resonators. Such a configuration is shown in FIG. 9(b) as metamaterial 902. As shown, metamaterial 902 includes inerter cells where a mass m and a stiffness kₘ are connected in series and are connected to the main chain at one end. Such a configuration results in a model metamaterial 902 with two degrees of freedom in each unit cell: u^{M} which is displacement of mass M on the main chain, u^{m} which is displacement of the resonator mass m. Applying the same Bloch-wave procedures used for previous numerical analysis yields closed-form expressions of band gap edge frequencies as follows:

$${f}_{L} = \frac{1}{2 π} \sqrt{{χ}_{m} - \sqrt{{χ}_{m}^{2} - 4 \frac{{κ}_{m}}{{μ}_{m}}}} ,$$

$${f}_{U} = \frac{1}{2 π} \sqrt{\frac{{κ}_{m}}{{μ}_{m}} + {κ}_{m}} ,$$

Where χₘ=κₘ/2+κₘ/(2μₘ)+2, κₘ=kₘ/K, and μₘ=m/M. Based on the equation for f_{L} shown above, in order to achieve ultra-low-frequency band gaps with f_{L}˜10⁻⁴, it can be true that the expression of μₘ/κₘ˜10⁻⁴. However, it can also be avoided that μₘ=m/M>>1 since it would make the embedded mass-resonator too heavy as compared to the structural matrix material, and would therefore be infeasible in most applications. Therefore, to make metamaterial 902 a desirable option, an ultra-low stiffness design can be adopted with μₘ˜1 and with 1>>κₘ. Performing analysis at this limit produces equations as follows:

$${f}_{L} \to \frac{1}{2 π} \sqrt{\frac{{κ}_{m}}{{μ}_{m}}} and Δ f \to \sqrt{{μ}_{m} + 1} - 1.$$

This approach and metamaterial for forming a band gap at ultra-low frequencies may initially seem possible. In fact, note that with μₘ=m/M=1 and κₘ=kₘ/K=5×10⁻⁷, the exact same dispersion band equations as plotted in FIG. 4A are obtained. However, using the same limit of μₘ˜1 and 1>>κₘ, the modal displacement ratios at the band gap edges are as follows:

$${U}^{b} / {U}^{M} \to 4 / {κ}_{m} at f = {f}_{L} ,$$

$${U}^{b} / {U}^{M} \to 1 / {μ}_{m} at f = {f}_{U} .$$

According to these modal displacement ratios, the design parameters of metamaterial 902 give rise to a very high modal displacement ratio at the lower band gap edge f_{L} (e.g., the grey square in FIG. 4A. This mathematical relationship means that the resonator mass m would vibrate with an amplitude that can be millions of times of the vibration amplitude of the main chain. Therefore, the ultra-low stiffness design here is also impractical in most application scenarios due to the high-level induced vibration in the resonator mass m. As such, this example shows it to be a poor choice compared to the inerter-based metamaterials described earlier.

Based on the analyses of all designs above, the inerter-based metamaterial 302 design depicted in FIG. 3(b) is the more beneficial design to achieve band gaps at the ultra-low dimensionless frequency of f=a/λ˜10⁻⁴ or lower. To further demonstrate the efficacy and practicality of this design, numerical studies were performed on two-dimensional lattices with embedded inerters. Band gaps can be realized in two-dimensional and three-dimensional metamaterials with other lever-based or geometry-based inertial amplified structures as well as two-dimensional structures that incorporate a flat plate or a beam as the base structure/matrix material with inerter-based resonators. However, no current designs of inerter-based metamaterials have so far been able to achieve band gaps at the ultra-low dimensionless frequency of f=a/λ˜10⁻⁴. In order to achieve band gaps at the ultra-low dimensionless frequency of f=a/λ˜10⁻⁴, the metamaterial 302 design illustrated in FIG. 3(b) was analyzed for viability in two-dimensional systems.

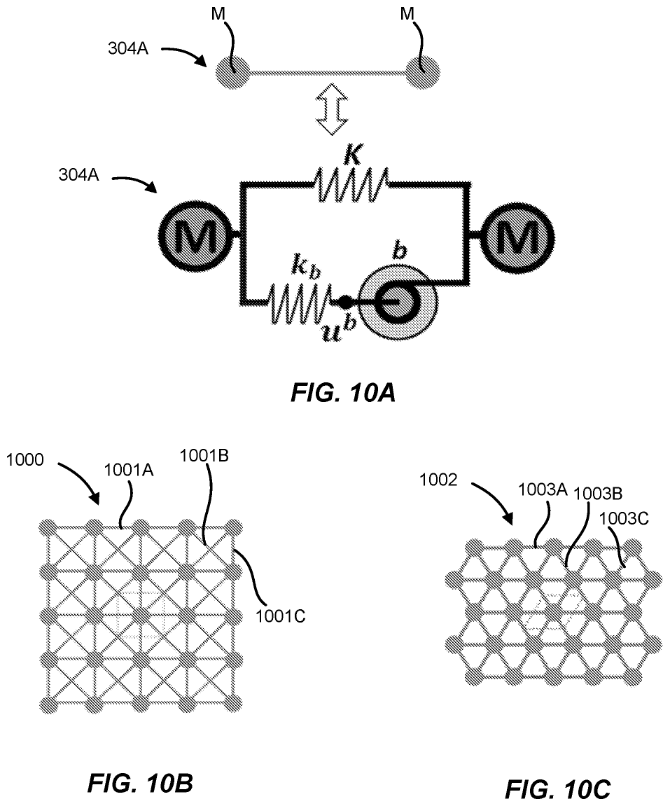

In the figures, various conceptual two-dimensional designs in the form of inerter-in-lattice configurations are illustrated that can represent various engineering structures. As shown in FIG. 10A, to simplify illustration, each of the inerter cells (e.g., inerter cell 304A) can be illustrated using a straight line with masses M on the ends to represent a connection with the main-chain stiffness K, side-chain stiffness k_{b}, and the side-chain inertance b, similar to as shown in FIG. 3(b). For purposes of analyzing two- and three-dimensional lattice structures of inerter cells, it is assumed that the displacement u^{b} at the point between stiffness k_{b} and inerter b is rigidly constrained in the lateral direction of the connection. Various lattice structures can be constructed using the inerter cells used as the basic building block, as illustrated as a line with two masses shown in FIG. 10A. For example, a square lattice 1000 of a plurality of inerter cells 1001A, 1001B, and 1001C can be constructed and arranged with the structural matrix material as shown in FIG. 10B. Alternatively, a triangle lattice 1002 of a plurality of inerter cells 1003A, 1003B, and 1003C can be constructed and arranged with the structural matrix material as shown in FIG. 10C. In both the square lattice 1000 and the triangle lattice 1002, the inerter cells can each be oriented along different attenuation axes. For example, the inerter cell 1001A can be oriented horizontally along a first attenuation axis, the inerter cell 1001B can be oriented diagonally along a second attenuation axis, and the inerter cell 1001C can be oriented vertically along a third attenuation axis, in order to provide vibration mitigation in multiple directions. Similarly, the inerter cell 1003A can be oriented horizontally along a first attenuation axis, the inerter cell 1003B can be oriented in a first diagonal direction along a second attenuation axis, and the inerter cell 1003C can be oriented in a second diagonal direction along a third attenuation axis, in order to provide vibration mitigation in multiple directions.

All connections shown in FIGS. 10B and 10C possess an embedded inerter b on the side chain. Specifically, for the square lattice 1000, the diagonal connections are used to make the lattice statically stable. The crossing point of the two diagonal connections at the center of each square in FIG. 10B is not a joint, and there are no interactions here between the two diagonal connections. Although the formulations and derivations are more challenging than those for two- and three-dimensional cases can be more complicated than for one-dimensional cases, the two-dimensional designs can still be analyzed via numerical results.

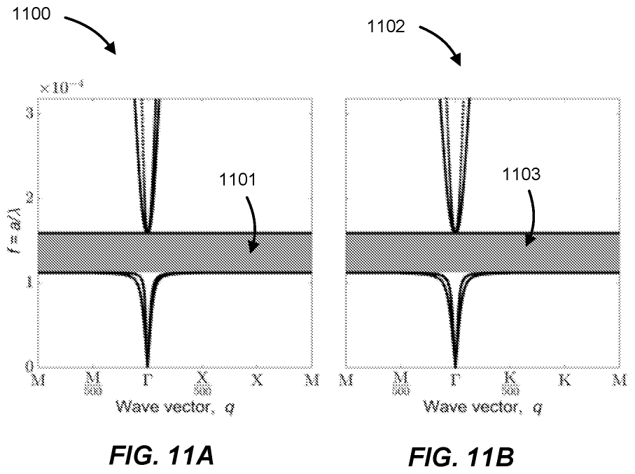

In the analysis, with the stiffness ratio being κ_{b}=k_{b}/K=1, and the inertance ratio μ_{b}=b/M=10⁶, a dispersion curve 1100 of the square lattice 1000 and a dispersion curve 1102 of the triangular lattice 1002 with embedded inerters can be plotted as shown in FIGS. 11A and 11B, respectively. As shown in the dispersion curves 1100 and 1102, a band gap 1101 and 1103 exists in both the case of the square lattice 1000 and the triangular lattice 1002. As established by the numerical analysis results, the band gaps 1101 and 1103 are both shown to have the numerical results of the analysis metamaterial 302 are f_{L}=1.125×10⁻⁴ with a relative gap size of Δf≈41.4%. Accordingly, the band gaps 1101 and 1103 match each other in the two different lattices (e.g., square and triangle). Furthermore, the band gaps 1101 and 1103 in the two different lattices also match the band gap 401 of the one-dimensional configuration shown in FIG. 3(b). Therefore, as established by the numerical analysis results of the lattice structures, the analyses and conclusions on band gaps illustrated in FIGS. 4A and 4B about one-dimensional metamaterials, such as metamaterial 302, are also established to extend to higher dimensional (e.g., two, three, four, etc.) scenarios. As further established, the difference in lattice configurations (e.g., whether square, triangular, or otherwise) has negligible impact on the ultra-low-frequency band gap resulting from the lattice structure. Conceptually, in the long wavelength limit of λ>>a, the unit-cell level geometries and small length-scale details have minimal influence on the metamaterial behavior in the low-frequency and ultra-low frequency regions. Accordingly, inerters in metamaterials can be much smaller than previously known (e.g., sized in the millimeter to centimeter scale) while still operating to mitigate low-frequency vibrations.

According to the analytical and numerical analyses above, guidelines and principles are established by this disclosure to design and implement elastic metamaterials that exhibit an ultra-low-frequency band gap. As outlined in the example shown in FIG. 3(b), advantageous inerter-based metamaterials can be designed and made based on the principles described herein. For example, each unit cell can have an embedded inerter with both ends, or terminals, connected to the base/structural matrix material. Furthermore, it can be advantageous for no additional resonator mass to be used in the inerter cell. To achieve band gaps at lower frequency, higher inertance can be used. To achieve wider band gaps, stiffer connection between the inerter and the base/structural matrix material can be used. These insights provide actionable guidelines for future research towards low-frequency vibration mitigation using metamaterials. Although this disclosure focused on periodic metamaterials, similar analyses can be extended to quasi-crystalline, hyper-uniform, amorphous, or other non-periodic inerter-based metamaterial designs.

Reference was made to the examples illustrated in the drawings and specific language was used herein to describe the same. It will nevertheless be understood that no limitation of the scope of the technology is thereby intended. Alterations and further modifications of the features illustrated herein and additional applications of the examples as illustrated herein are to be considered within the scope of the description.

Furthermore, the described features, structures, or characteristics may be combined in any suitable manner in one or more examples. In the preceding description, numerous specific details were provided, such as examples of various configurations to provide a thorough understanding of examples of the described technology. It will be recognized, however, that the technology may be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements may be devised without departing from the spirit and scope of the described technology. The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

What is claimed is:

1. An inerter-based metamaterial for low-frequency vibration attenuation, comprising:
a structural matrix material; and
an inerter array embedded within the structural matrix material, the inerter array comprising:
a first inerter cell oriented along a first attenuation axis; and
a second inerter cell oriented along a second attenuation axis different from the first attenuation axis;
wherein the first inerter cell comprises a first inerter and the second inerter cell comprises a second inerter.

2. The metamaterial of claim 1, wherein the first inerter and the second inerter are microinerters.

3. The metamaterial of claim 1, wherein the inerter array comprises a three-dimensional inerter array of inerter cells embedded within the structural matrix material, the three-dimensional inerter array comprising:
a first inerter cell oriented along a first attenuation axis;
a second inerter cell oriented along a second attenuation axis different from the first attenuation axis; and
a third inerter cell oriented along a third attenuation axis different from the first attenuation axis and the second attenuation axis.

4. The metamaterial of claim 1, wherein the first inerter cell comprises a first spring connected to the first inerter.

5. The metamaterial of claim 4, wherein the first spring is connected in series to the first inerter.

6. The metamaterial of claim 1, wherein the second inerter cell comprises a second spring connected to the second inerter.

7. The metamaterial of claim 6, wherein the second spring is connected in series to the second inerter.

8. The metamaterial of claim 1, wherein the first inerter cell and the second inerter cell are separated from each other by at least a portion of the structural matrix material.

9. The metamaterial of claim 1, wherein the first inerter cell comprises a first end and a second end.

10. The metamaterial of claim 9, wherein the first inerter cell is connected to the structural matrix material at both the first end and the second end.

11. The metamaterial of claim 10, wherein the second inerter cell comprises a first end and a second end.

12. The metamaterial of claim 11, wherein the second inerter cell is connected to the structural matrix material at both the first end and the second end.

13. The metamaterial of claim 1, wherein the inerter array comprises a plurality of inerter cells numbering three or more.

14. The metamaterial of claim 1, wherein the inerter array comprises a plurality of inerter cells numbering 5 to 10,000.

15. The metamaterial of claim 13, wherein most of the plurality of inerter cells of the inerter array are separated from other inerter cells of the inerter array by at least a portion of the matrix material such that the plurality of inerter cells are connected to each other via the structural matrix material.

16. The metamaterial of claim 13, wherein each of the plurality of inerter cells of the inerter array are separated from other inerter cells of the inerter array by at least a portion of the structural matrix material such that the plurality of inerter cells are connected to each other via the structural matrix material.

17. The metamaterial of claim 13, wherein the plurality of inerter cells of the inerter array are arranged in a square lattice structure with the structural matrix material.

18. The metamaterial of claim 13, wherein the plurality of inerter cells of the inerter array are arranged in a triangular lattice structure with the structural matrix material.

19. The metamaterial of claim 13, wherein each of the plurality of inerter cells comprise an inerter and a spring.

20. The metamaterial of claim 19, wherein the inerter is connected in series with the spring in each of the plurality of inerter cells.

21. The metamaterial of claim 13, wherein each of the plurality of inerter cells comprise a first end and a second end, and each of the plurality of inerter cells are connected to the structural matrix material at both the first end and the second end.

22. The metamaterial of claim 13, wherein at least some inerter cells of the plurality of inerter cells comprise a first end and a second end, and the at least some inerter cells of the plurality of inerter cells are connected to the structural matrix material at both the first end and the second end.

23. The metamaterial of claim 13, wherein the inerters are mass-inerters and are at least one of a ball-screw inerter, a rack-and-pinion inerter, a hydraulic inerter, a fluid inerter, a living-hinge inerter, and a planetary-gear inerter.

24. A building structure system comprising:
an inerter-based metamaterial for low-frequency vibration attenuation, comprising:
a structural matrix material at least partially forming a structure of a building; and
an inerter array embedded within the structural matrix material, the inerter array comprising:
a first inerter cell oriented along a first attenuation axis; and
a second inerter cell oriented along a second attenuation axis different from the first attenuation axis;
wherein the first inerter cell comprises a first inerter and the second inerter cell comprises a second inerter.
